(19) United States
(12) Patent Application Publication
(10) Pub. No.: US 2026/0037868 A1
(43) Pub. Date: Feb. 5, 2026

(54) PREDICTION DEVICE, PREDICTION METHOD, AND NON-TRANSITORY COMPUTER READABLE MEDIUM

(71) Applicant: NEC Corporation, Tokyo (JP)

(72) Inventors: Keita SAKUMA, Tokyo (JP); Ryuta Matsuno, Tokyo (JP); Masakazu Hirokawa, Tokyo (JP)

(73) Assignee: NEC Corporation, Tokyo (JP)

(21) Appl. No.: 19/271,922

(22) Filed: Jul. 17, 2025

(30) Foreign Application Priority Data
Aug. 1, 2024 (JP) 2024-126080

(51) Int. Cl. G06N 20/00

(52) U.S. Cl. CPC G06N 20/00

(57) ABSTRACT

A prediction device includes at least one memory storing instructions, and at least one processor configured to execute the instructions to update some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and output an integrated prediction result obtained by integrating prediction results predicted by each model with reference to model input information included in prediction target information related to a prediction target using a weight vector selected based on the prediction target information from among the plurality of first weight vectors and the plurality of second weight vectors for decision making.

### INCORPORATION BY REFERENCE

This application is based upon and claims the benefit of priority from Japanese patent application No. 2024-126080, filed on Aug. 1, 2024, the disclosure of which is incorporated herein in its entirety by reference.

### TECHNICAL FIELD

The present disclosure relates to a technique for performing prediction.

### BACKGROUND ART

A technique for dynamically changing a weight given to each model in ensemble prediction is known. For example, JP 2016-45799 A discloses a technique of calculating a weight to be given to each model according to a degree of coincidence between a prediction value predicted by each model based on a detected value obtained in a period going back by a predetermined retrospective period from a time point to be predicted and an actual value obtained in the period.

### SUMMARY

The technique described in JP 2016-45799 A has a problem that the accuracy of ensemble prediction decreases in a case where the distribution of information related to the prediction target locally changes.

The present disclosure has been made in view of the above problems, and an example object thereof is to provide a technique for performing ensemble prediction with high accuracy even in a case where a distribution of information related to a prediction target locally changes.

A prediction device according to an example aspect of the present disclosure includes at least one memory storing instructions, and at least one processor configured to execute the instructions to update some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and output an integrated prediction result obtained by integrating prediction results predicted by each model with reference to model input information included in prediction target information related to a prediction target using a weight vector selected based on the prediction target information from among the plurality of first weight vectors and the plurality of second weight vectors.

A prediction method according to an example aspect of the present disclosure includes weight update processing in which at least one processor updates some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and prediction processing in which the at least one processor outputs an integrated prediction result obtained by integrating prediction results predicted by each model with reference to model input information included in prediction target information related to a prediction target using a weight vector selected based on the prediction target information from among the plurality of first weight vectors and the plurality of second weight vectors.

A non-transitory computer-readable medium according to an example aspect of the present disclosure stores a program that causes a computer to execute a weight update processing of updating some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and a prediction processing of outputting an integrated prediction result obtained by integrating prediction results predicted by each model with reference to model input information included in prediction target information related to a prediction target using a weight vector selected based on the prediction target information from among the plurality of first weight vectors and the plurality of second weight vectors.

According to an example aspect of the present disclosure, it is possible to provide a technique for performing ensemble prediction with high accuracy even in a case where a distribution of information related to a prediction target locally changes.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a configuration of a prediction device according to the present disclosure;

FIG. 2 is a flowchart illustrating a flow of a prediction method according to the present disclosure;

FIG. 3 is a block diagram illustrating a configuration of the prediction device according to the present disclosure;

FIG. 4 is a diagram for explaining processing in the prediction device according to the present disclosure;

FIG. 5 is a flowchart for explaining an example of a detailed flow of weight update processing according to the present disclosure;

FIG. 6 is a flowchart for explaining an example of a detailed flow of prediction processing according to the present disclosure;

FIG. 7 is a block diagram illustrating a configuration of a prediction device according to the present disclosure;

FIG. 8 is a diagram illustrating a display example by the prediction device according to the present disclosure;

FIG. 9 is a schematic diagram illustrating a specific example of a prediction device applied in a medical field according to the present disclosure;

FIG. 10 is a schematic diagram illustrating a specific example of a prediction device applied in a retail field according to the present disclosure; and

FIG. 11 is a block diagram illustrating a hardware configuration example of a computer that functions as devices according to the present disclosure.

### EXAMPLE EMBODIMENT

Hereinafter, example embodiments of the present disclosure will be described. However, the present disclosure is not limited to the example embodiments which will be described below, and various modifications can be made within the scope described in the claims. For example, example embodiments obtained by appropriately combining technical means adopted in the following example embodiments can also be included in the scope of the present disclosure. Example embodiments obtained by appropriately omitting some of the technical means adopted in the following example embodiments can also be included in the scope of the present disclosure. Effects mentioned in the following example embodiments are examples of effects expected in the example embodiments, and do not define the extension of the present disclosure. That is, example embodiments that do not achieve the effects mentioned in the following example embodiments can also be included in the scope of the present disclosure.

### First Example Embodiment

A first example embodiment that is an example embodiment of the present disclosure will be described in detail with reference to the drawings. The present example embodiment is a basic form of each example embodiment which will be described below. The application range of each technical means adopted in the present example embodiment is not limited to the present example embodiment. That is, each technical means adopted in the present example embodiment can also be adopted in other example embodiments included in the present disclosure as long as no particular technical problem occurs. Each technical means illustrated in the drawings referred to for describing the present example embodiment can also be adopted in other example embodiments included in the present disclosure as long as no particular technical problem occurs.

### (Configuration of Prediction Device)

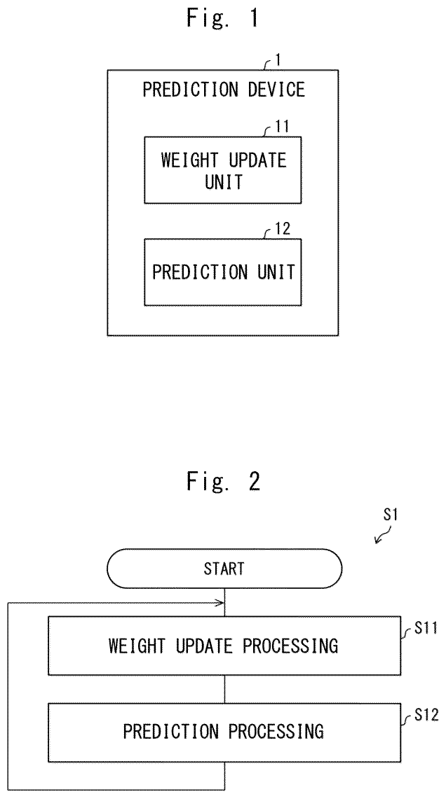

A configuration of a prediction device 1 will be described with reference to FIG. 1. FIG. 1 is a block diagram illustrating a configuration of the prediction device 1. As illustrated in FIG. 1, the prediction device 1 includes a weight update unit 11 and a prediction unit 12. The weight update unit 11 updates some or all of the plurality of first weight vectors and some or all of the plurality of second weight vectors based on an evaluation result obtained by evaluating performance of each of the plurality of models with reference to evaluation information including model input information for evaluation and a true value relevant to the model input information, and the evaluation information. Here, the model input information for evaluation is, as an example, information obtained over time after the operation of the plurality of models has started. The second weight vector is a vector having a weight given to each of the plurality of first weight vectors as a component. The weight update unit 11 also functions as an acquisition means that acquires the evaluation information.

The prediction unit 12 outputs an integrated prediction result obtained by integrating prediction results predicted by each model with reference to model input information included in prediction target information related to a prediction target, using a weight vector selected based on the prediction target information among the plurality of first weight vectors and the plurality of second weight vectors. As an example, the prediction unit 12 outputs an integrated prediction result obtained by integrating the prediction results by models using the second weight vector selected based on the prediction target information and the first weight vector selected according to the selected second weight vector. The second weight vector selected based on the prediction target information is, for example, one vector. The first weight vector selected according to the selected second weight vector may be one vector or a plurality of vectors. The prediction unit 12 also functions as an acquisition means that acquires the prediction target information.

The prediction target is a target for performing prediction using each model, and includes, for example, a sales amount, a hospital bed usage rate, a classification of human behavior, and the like, but is not limited thereto. The prediction target is also referred to as, for example, a target variable. The model input information is information input to each model, and is also referred to as an explanatory variable. In a case where the prediction target is the sales amount of the target date, the model input information may include, for example, the weather of the target date. In a case where the prediction target is the hospital bed usage rate after one week, the model input information may include the latest hospital bed usage rate. In the case that the prediction target is the classification of the human behavior, the model input information may include the image in which the person is photographed.

The model input information for evaluation is information obtained over time after the start of operation, and is different from the model input information used to evaluate the performance of each model at the time of generating the model. As the model input information for evaluation, the model input information (the explanatory variable described above as an example) included in the prediction target information referred to by the prediction unit 12 in the past prediction processing may be applied, but the present disclosure is not limited thereto. The evaluation information includes a true value relevant to the model input information for evaluation, and the weight update unit 11 evaluates the performance of each model and the prediction performance of each first weight vector based on the true value. The weight update unit 11 selects some or all of the plurality of first weight vectors as update targets based on the evaluation information, and updates the selected first weight vector to be updated based on the performance evaluation result of each model. The weight update unit 11 updates some or all of the plurality of second weight vectors according to the evaluation result of the first weight vector. However, these examples are not intended to limit the present example embodiment.

### (Effects of Prediction Device)

As described above, the prediction device 1 employs a configuration including the weight update unit 11 and the prediction unit 12 described above. Therefore, according to the prediction device 1, it is possible to accurately update some or all of the plurality of first weight vectors and some or all of the plurality of second weight vectors based on the evaluation result of each model evaluated with reference to the evaluation information and based on the evaluation information referred to for obtaining the evaluation result. At the time of performing prediction, the weight vector selected based on the prediction target information from the plurality of first weight vectors and the plurality of second weight vectors thus updated is used, and thus, it is possible to obtain an effect that the ensemble prediction can be performed with high accuracy even in a case where the distribution of the model input information included in the prediction target information locally changes.

### (Implementation Example by Program)

In a case where the prediction device 1 is configured by a computer including at least one processor and a memory, the following prediction program is stored in the memory. The prediction program is a program that causes a computer to function as the prediction device 1, and causes the computer to function as: a weight update unit 11 that updates some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and a prediction unit 12 that outputs an integrated prediction result obtained by integrating prediction results predicted by each model with reference to model input information included in prediction target information related to a prediction target using a weight vector selected based on the prediction target information from among the plurality of first weight vectors and the plurality of second weight vectors.

### (Flow of Prediction Method)

A flow of a prediction method S1 will be described with reference to FIG. 2. FIG. 2 is a flowchart illustrating the flow of the prediction method S1. As illustrated in FIG. 2, the prediction method S1 includes weight update processing S11 and prediction processing S12. In the weight update processing S11, at least one processor updates some or all of the plurality of first weight vectors and some or all of the plurality of second weight vectors based on an evaluation result obtained by evaluating performance of each of the plurality of models with reference to evaluation information including model input information for evaluation and a true value relevant to the model input information, and the evaluation information. Here, the model input information for evaluation is, as an example, information obtained over time after the operation of the plurality of models has started. The second weight vector is a vector having a weight given to each of the plurality of first weight vectors as a component.

Subsequently, in prediction processing S12, at least one processor outputs an integrated prediction result obtained by integrating prediction results predicted by each model with reference to model input information included in prediction target information related to a prediction target, using a weight vector selected based on the prediction target information among the plurality of first weight vectors and the plurality of second weight vectors.

At least one processor may repeatedly execute the weight update processing S11 and the prediction processing S12. However, the weight update processing S11 and the prediction processing S12 may be executed independently of each other, and the execution order and the execution timing of each processing are not defined. For example, the prediction processing S12 is not necessarily executed next to the weight update processing S11. The weight update processing S11 may be repeatedly executed at an arbitrary timing, and the prediction processing S12 may be repeatedly executed in response to occurrence of a prediction request.

### (Effect of Prediction Method)

As described above, the prediction method S1 employs a configuration including the weight update processing S11 and the prediction processing S12 described above. Therefore, according to the prediction method S1, it is possible to accurately update some or all of the plurality of first weight vectors and some or all of the plurality of second weight vectors based on the evaluation result of each model evaluated with reference to the evaluation information and based on the evaluation information referred to for obtaining the evaluation result. At the time of performing prediction, the weight vector selected based on the prediction target information from the plurality of first weight vectors and the plurality of second weight vectors thus updated is used, and thus, it is possible to obtain an effect that the ensemble prediction can be performed with high accuracy even in a case where the distribution of the model input information included in the prediction target information locally changes.

### Second Example Embodiment

A second example embodiment that is an example of an example embodiment of the present disclosure will be described in detail with reference to the drawings. Components having the same functions as the components described in the above-described example embodiment are denoted by the same reference signs, and the description thereof will be appropriately omitted. The application range of each technical means adopted in the present example embodiment is not limited to the present example embodiment. That is, each technical means adopted in the present example embodiment can also be adopted in other example embodiments included in the present disclosure as long as no particular technical problem occurs. Each technique illustrated in each of the drawings referred to for describing the present example embodiment can be employed in the other example embodiments included in the present disclosure within a range in which no particular technical problem occurs.

### (Configuration of Prediction Device)

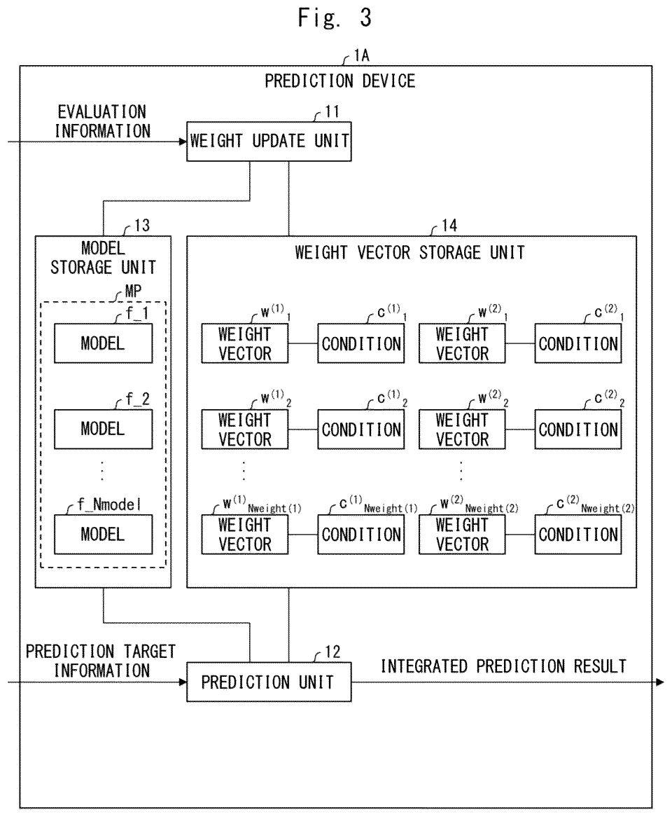

A configuration of a prediction device 1A will be described with reference to FIG. 3. FIG. 3 is a block diagram illustrating a configuration of the prediction device 1A. The prediction device 1A includes a model storage unit 13 and a weight vector storage unit 14 in addition to the weight update unit 11 and the prediction unit 12 included in the prediction device 1.

### (Model Storage Unit)

The model storage unit 13 stores Nmodel models f_1, f_2, . . . , and f_Nmodel. Nmodel is a natural number of 2 or more. In other words, the model storage unit 13 stores a model set F expressed by the following Equation (1). The model set F may be referred to as a model pool MP.

$$ℱ = {\{ f\_i \}}_{i = 1}^{{N}^{model}} \qquad Equation ( 1 )$$

Each model f_i is a model that outputs a prediction result y_i with reference to the model input information. The prediction results y_i output from the models f_i with reference to the same model input information may be different from each other.

As an example, an example in which the prediction target is a sales amount on the target date will be described. In this example, the sales prediction values output from the models f_i with reference to the same model input information may be different from each other. For example, the model input information may include a store periphery image captured around the store on the target date, a weekday/holiday label indicating a weekday or holiday, and weather. Each model f_i may be a model that refers to the model input information and outputs a sales prediction value of the target date as a prediction result y_i.

Here, the prediction target information to be referred to by the prediction unit 12 to be described later in detail includes at least model input information. The prediction target information may further include additional information that is not input to each model f_i, in addition to the model input information. The evaluation information referred to by the weight update unit 11 to be described later in detail includes at least the model input information for evaluation. The evaluation information may further include additional information for evaluation in addition to the model input information for evaluation.

For example, in a case where the model input information includes a store periphery image, examples of the additional information include a resolution of the store periphery image, a photographing time, a type of a photographing device, a photographer, or a combination thereof. However, examples of the model input information and the additional information are not limited thereto. The prediction target information and the evaluation information only need to include at least the model input information, and do not necessarily include the additional information. However, in a case where a plurality of conditions to be described later is determined with reference to the additional information, both the prediction target information and the evaluation information include the model input information and the additional information.

Each model f_i may be a machine learning model or may be a model other than the machine learning model. For example, examples of the machine learning model include, but are not limited to, a deep neural network (DNN), a gradient boosting decision tree (GBDT), a linear regression model, and the like. Examples of a model that is not a machine learning model include, but are not limited to, a rule-based model. At least two models f_i1 and f_i2 (i1≠i2) included in the model set F may be the same type of model or different types of models. In a case where at least two models f_i1 and f_i2 included in the model set F are the same type of machine learning model, the two models f_i1 and f_i2 may be learned at least partially by different training data sets or may have different hyperparameters. The model f_i may be referred to as fᵢ, and the prediction result y_i may be referred to as yᵢ.

### (Weight Vector Storage Unit)

The weight vector storage unit 14 stores:
Nweight(1) first weight vectors w⁽¹⁾_1, w⁽¹⁾_2, . . . , w⁽¹⁾_Nweight(1); and
Nweight(2) second weight vectors w⁽²⁾_1, w⁽¹⁾_2, . . . , w⁽¹⁾_Nweight(2).
   Here, Nweight(1) and Nweight(2), as an example, are both a natural number of 2 or more. w⁽¹⁾_j may be written as w⁽¹⁾_j, or w⁽²⁾_k may be written as w⁽²⁾_k. In other words, the weight vector storage unit 14 stores a first weight set W⁽¹⁾ expressed by the following Equation (2) and a second weight set W⁽²⁾ expressed by the following Equation (3).

$${W}^{( 1 )} = {\{ {w}_{j}^{( 1 )} \}}_{j = 1}^{{N}^{weight ( 1 )}} \qquad Equation ( 2 )$$

$${W}^{( 2 )} = {\{ {w}_{k}^{( 2 )} \}}_{k = 1}^{{N}^{weight ( 2 )}} \qquad Equation ( 3 )$$

### (First Weight Vector)

The first weight vector w⁽¹⁾_j is a vector having Nmodel weights w⁽¹⁾_j_i as elements (also denoted as w⁽¹⁾_j_i or w⁽¹⁾_{j,i}), and is expressed by the following Equation (4).

$${w}_{j}^{( 1 )} = ( {w}_{j 1}^{( 1 )} , {w}_{j 2}^{( 1 )} , … , {w}_{j Nmodel}^{( 1 )} ) \qquad Equation ( 4 )$$

Here, the weight w⁽¹⁾_j_i represents a weight given to the model f_i in a case where the first weight vector w⁽¹⁾_j is selected. The weight vector w⁽¹⁾_j may be updated by the weight update unit 11, and the initial value of each element is arbitrarily determined. For example, the initial values of the elements may all be equal, or may be randomly determined.

Each of the plurality of first weight vectors w⁽¹⁾_j stored in the weight vector storage unit 14 is associated with at least one of a plurality of first conditions that can be satisfied by the prediction target information and can be satisfied by the evaluation information. Here, for certain prediction target information, there may be a plurality of the first conditions c⁽¹⁾_j satisfied by the prediction target information. Each of the plurality of first conditions c⁽¹⁾_j may be a condition that can be satisfied by the model input information. As an example, in a case where the model input information includes a weekday/holiday label and a weather label, a condition c⁽¹⁾_1 “sunny weekday” and a condition c⁽¹⁾_2 “sunny holiday” may be set as the plurality of first conditions c⁽¹⁾_1 and c⁽¹⁾_2. In a case where the evaluation information and the prediction target information include the additional information, each of the plurality of first conditions c⁽¹⁾_j may be a condition that can be satisfied by the additional information, or may be a condition that can be satisfied by both the model input information and the additional information.

Here, the first weight vector and the first condition are not necessarily relevant to each other on a one-to-one basis, but here, an example on a one-to-one basis will be mainly described, and the first condition on a one-to-one basis with the first weight vector w⁽¹⁾_j will be described as a first condition c⁽¹⁾_j. In other words, the first weight vector w⁽¹⁾_j is associated with the first condition c⁽¹⁾_j. In a case where the first weight vector w⁽¹⁾_j and the first condition c⁽¹⁾_j are relevant to each other on a one-to-one basis, the number of the plurality of first conditions c⁽¹⁾_j is equal to the number of first weight vectors Nweight(1). The first condition c⁽¹⁾_j is also referred to as c⁽¹⁾ⱼ.

### (Second Weight Vector)

On the other hand, the second weight vector w⁽²⁾_k is a vector having Nweight(1) weights w⁽²⁾_k_j as elements (also denoted as w⁽²⁾ₖⱼ or w⁽²⁾_{k,j}), and is expressed by the following Equation (5).

$${w}_{k}^{( 2 )} = ( {w}_{k 1}^{( 2 )} , {w}_{k 2}^{( 2 )} , … , {w}_{k Nweight ( 1 )}^{( 2 )} ) \qquad Equation ( 5 )$$

Here, the weight w⁽²⁾_k_j represents a weight given to the first weight vector w⁽¹⁾_j in a case where the second weight vector w⁽¹⁾_k is selected. The weight vector w⁽²⁾_k may be updated by the weight update unit 11, and the initial value of each element is arbitrarily determined. For example, the initial values of the elements may all be equal, or may be randomly determined.

Each of the plurality of second weight vectors w⁽²⁾_k stored in the weight vector storage unit 14 is associated with at least one of a plurality of second conditions that can be satisfied by the prediction target information and can be satisfied by the evaluation information. Here, for certain prediction target information, it is preferable that the second condition c⁽²⁾_k satisfied by the prediction target information is configured to be determined as one. Each of the plurality of second conditions c⁽²⁾_k may be a condition that can be satisfied by the model input information. The plurality of second conditions c⁽²⁾_k may include the same condition as the above-described first condition c⁽¹⁾_j. As an example, in a case where the model input information includes a weekday/holiday label and a weather label, a condition c⁽²⁾_1 “sunny weekday” and a condition c⁽²⁾_2 “sunny holiday” may be set as the plurality of second conditions c⁽²⁾_1 and c⁽²⁾_2. In a case where the evaluation information and the prediction target information include the additional information, each of the plurality of second conditions c⁽²⁾_k may be a condition that can be satisfied by the additional information, or may be a condition that can be satisfied by both the model input information and the additional information.

Here, the second weight vector and the second condition are not necessarily relevant to each other on a one-to-one basis, but here, an example of one-to-one basis will be mainly described, and the second condition relevant to the second weight vector w⁽²⁾_k on a one-to-one basis will be described as a second condition c⁽²⁾_k. In other words, the second weight vector w⁽²⁾_k is associated with the second condition c⁽²⁾_k. In a case where the second weight vector w⁽²⁾_k and the second condition c⁽²⁾_k are relevant to each other on a one-to-one basis, the number of the plurality of second conditions c⁽²⁾_k is equal to the number Nweight(2) of the second weight vectors. The second condition c⁽²⁾_k is also referred to as c⁽²⁾ₖ.

As described above, the second weight vector w⁽²⁾_k is a vector in which the weight given to the first weight vector w⁽¹⁾_j as the component w⁽²⁾_k_j. Therefore, the second weight vector w⁽²⁾_k can also be expressed as a weight vector for soft-determination as to which of the plurality of first weight vectors w⁽¹⁾_j to use in the prediction processing. Here, “soft-determine” refers to, as an example, using a plurality of first weight vectors w⁽¹⁾_j in combination using multistage coefficients.

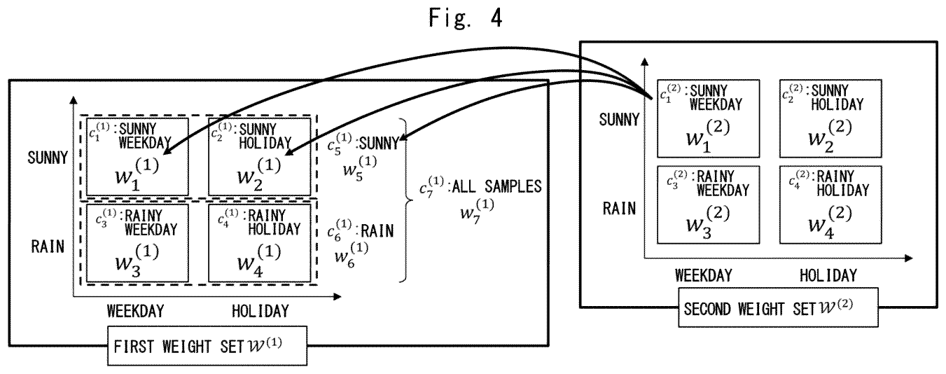

FIG. 4 illustrates an example of a relationship between
the first weight vector w⁽¹⁾ⱼ (j=1, . . . , 7),
the first condition c⁽¹⁾ⱼ (=1, . . . , 7),
the second weight vector w⁽²⁾ₖ (k=1, . . . , 4), and
the second condition c⁽²⁾ₖ (k=1, . . . , 4).
   As illustrated in FIG. 4, each of the first conditions c⁽¹⁾ⱼ (j=1, . . . , 7) is associated with each of the first weight vectors w⁽¹⁾ⱼ (j=1, . . . , 7). Similarly, each of the second conditions c⁽²⁾ₖ (k=1, . . . , 4) is associated with each of the second weight vectors w⁽²⁾(k=1, . . . , 4).

As illustrated in FIG. 4, the second weight vector w⁽²⁾ₖ has components relevant to the first weight vectors w⁽¹⁾ⱼ. More specifically, in FIG. 4, the second weight vector w⁽²⁾₁ includes seven components (elements) relevant to the number of first weight vectors w⁽¹⁾ⱼ.

w⁽²⁾₁=(w⁽²⁾₁₁, w⁽²⁾₁₂, w⁽²⁾₁₃, w⁽²⁾₁₄, w⁽²⁾₁₅, w⁽²⁾₁₆, w⁽²⁾₁₇), and among them, FIG. 4 illustrates a case where
a component w⁽²⁾₁₁ relevant to a component w⁽¹⁾₁,
a component w⁽²⁾₁₂ relevant to a component w⁽¹⁾₂, and
a component w⁽²⁾₁₅ relevant to a component w⁽¹⁾₅
   have a large weight is shown (relevant to an arrow illustrated in FIG. 4).

In the present example embodiment, the plurality of first weight vectors w⁽¹⁾_j may include a weight vector associated with a condition obtained by integrating any two or more conditions included in the plurality of first conditions c⁽¹⁾_j. As an example, in the example illustrated in FIG. 4, the plurality of first conditions c⁽¹⁾ⱼ (j=1, . . . , 7) include:
a condition c⁽¹⁾₅ “sunny” obtained by integrating the first condition c⁽¹⁾₁ “sunny weekday” and the first condition c⁽¹⁾₂ “sunny holiday”. Similarly, in the plurality of first conditions c⁽¹⁾ⱼ (j=1, . . . , 7),
a condition c⁽¹⁾₆ “rain” obtained by integrating the first condition c⁽¹⁾₃ “rainy weekday” and the first condition c⁽¹⁾₄ “rainy holiday” is included. Further, in the plurality of first conditions c⁽¹⁾ⱼ (j=1, . . . , 7),
a condition c⁽¹⁾₇ “all samples” obtained by integrating the first condition c⁽¹⁾₅ “sunny” and the first condition c⁽¹⁾₆ “rainy” is included.

Then, the first weight vector (w⁽¹⁾₅, w⁽¹⁾₆, w⁽¹⁾₇) is set in association with each of the first conditions (c⁽¹⁾₅, c⁽¹⁾₆, c⁽¹⁾₇) obtained by such integration. Furthermore, the second weight vector w⁽²⁾ₖ including the weight(w⁽²⁾ₖ₅, w⁽²⁾ₖ₆, w⁽²⁾ₖ₇) given to such a first weight vector (w⁽¹⁾₅, w⁽¹⁾₆, w⁽¹⁾₇) as a component is set. With such a configuration, even if the setting of the first condition c⁽¹⁾ⱼ is not necessarily appropriate, suitable ensemble prediction can be executed.

The condition obtained by integrating the plurality of conditions can also be expressed as, for example, a condition obtained by extending the plurality of conditions, a condition reflecting characteristics of the plurality of conditions, or a condition obtained by deriving the plurality of conditions. As a specific example, in a case where the condition C1 and the condition C2 are given as

$$1 \leq x < 1 \; 00 , \qquad C1$$

$$100 \leq x < 200 , \qquad C2$$

the condition C3 obtained by integrating the condition C1 and the condition C2 may be a condition
C3: 50<x<150 obtained by the partial space of C1 and the partial space of C2, or may be a condition

$$- 50 \leq x < 250 \qquad C3$$

extended to include both the condition C1 and the condition C2. The condition obtained by integrating the plurality of conditions may be a condition obtained by the logical sum of the plurality of conditions. The same applies to other portions of the present specification.

### (Prediction Unit)

The prediction unit 12 selects the second weight vector w⁽²⁾_k associated with the second condition c⁽²⁾_k satisfied by the prediction target information among the plurality of second conditions c⁽²⁾_k. The prediction unit 12 outputs an integrated prediction result obtained by integrating the prediction results y_i output from each of the plurality of models f_i with respect to the model input information included in the prediction target information by using a combination of
the selected second weight vector w⁽²⁾_k and
the first weight vector w⁽¹⁾_j indirectly selected by the selected second weight vector w⁽²⁾_k. For example, in the case of the regression task, the processing of calculating the integrated prediction result is expressed by the following Equation (6).

$$\hat{y} = {\sum }_{j} {w}_{k , j}^{( 2 )} {\sum }_{i} {w}_{j , i}^{( 1 )} {f}_{i} ( x ) \qquad Equation ( 6 )$$

In Equation (6), the left side (hereinafter, described as y\hat{ }) indicates the integrated prediction result. x represents model input information included in the prediction target information. fᵢ(x) represents a prediction result yᵢ by the model fᵢ. w⁽²⁾_{k,j} is an element associated with the first weight vector w⁽¹⁾ⱼ among elements of the second weight vector w⁽²⁾ₖ associated with the second condition c⁽²⁾ₖ satisfied by the model input information. w⁽¹⁾_{j,i} is an element relevant to the model fᵢ among the elements of the first weight vector w⁽¹⁾ⱼ. In Equation (6), each weight vector is assumed to be normalized as follows:

$${\sum }_{j} {w}_{k , j}^{( 2 )} = 1 ; and$$

$${\sum }_{i} {w}_{j , i}^{( 1 )} = 1.$$

In the case of the classification task, as an example, fᵢ(x) represents a vector of a class number dimension, and the prediction probability for each class label i is expressed by fᵢ(x). Then, the prediction unit 12 can calculate the post-integration prediction probability using the same equation as the above Equation (6). In a case where a label is finally determined as a prediction value, the prediction unit 12 determines a class label having the highest probability as the label as the prediction value.

In a case where the prediction target information includes the additional information, the prediction unit 12 may select any one of the plurality of second weight vectors w⁽²⁾ₖ based on the model input information and the additional information included in the prediction target information. In this case, w⁽²⁾_{k,j} in Equation (6) may be an element associated with the first weight vector w⁽¹⁾ⱼ among the elements of the second weight vector w⁽²⁾ₖ associated with the second condition c⁽²⁾ₖ satisfied by one or both of the model input information and the additional information.

For example, an example in which the prediction target information includes a store periphery image and a weekday/holiday label as the model input information, and includes the resolution of the store periphery image as the additional information will be described. In this example, the second condition c⁽²⁾₁ may be “weekday and high resolution”, the second condition c⁽²⁾₂ may be “weekday and low resolution”, the second condition c⁽²⁾₃ may be “holiday and high resolution”, and the second condition c⁽²⁾₄ may be “holiday and low resolution”. In this case, the number of the second weight vectors Nweight(2) may be 4, which is the number of conditions.

For example, a set of prediction target information may be input to the prediction unit 12. Such a set X is expressed by the following Equation (7).

$$X = {\{ ( {x}_{m} , {v}_{m} ) \}}_{m = 1}^{{N}^{input}} \qquad Equation ( 7 )$$

In Equation (7), xₘ represents m-th model input information included in Ninput pieces of prediction target information. vₘ indicates m-th additional information included in the Ninput pieces of prediction target information.

In this case, the prediction unit 12 outputs a set Y of integrated prediction results relevant to the set X. Such a set Y is expressed by the following Equation (8).

$$\hat{𝓎} = {\{ \}}_{m = 1}^{{N}^{input}} \qquad Equation ( 8 )$$

In Equation (8), yₘ represents an integrated prediction result relevant to m-th prediction target information.

### (Weight Update Unit)

The weight update unit 11 is configured as follows in addition to being configured similarly to the first example embodiment. The weight update unit 11 updates the first weight vector w⁽¹⁾_j associated with the first condition c⁽¹⁾_j satisfied by the evaluation information among the plurality of first conditions c⁽¹⁾_j. For example, in a case where the model input information for evaluation included in the evaluation information includes a weekday/holiday label indicating a weekday and a weather label indicating sunny, the evaluation information satisfies the first condition c⁽¹⁾_1 “sunny weekday”. Therefore, the weight update unit 11 sets the first weight vector w⁽¹⁾_1 associated with the first condition c⁽¹⁾_1 as an update target.

The weight update unit 11 updates the second weight vector w⁽²⁾_k associated with the second condition c⁽²⁾_k satisfied by the evaluation information among the plurality of second conditions c⁽²⁾_k. For example, in a case where the model input information for evaluation included in the evaluation information includes a weekday/holiday label indicating a weekday and a weather label indicating sunny, the evaluation information satisfies the second condition c⁽²⁾_1 “sunny weekday”. Therefore, the weight update unit 11 sets the second weight vector w⁽²⁾_1 associated with the second condition c⁽²⁾_1 as an update target.

Here, a case where the model input information included in the prediction target information referred to by the prediction unit 12 in the past prediction processing is applied as the model input information for evaluation included in the evaluation information will be described. For example, the weight update unit 11 may use the model input information as the model input information for evaluation in response to acquisition of a true value (for example, the sales actual value of the target date) relevant to the model input information (for example, store periphery image of target date and weekday/holiday label) referred to by the prediction unit 12 in the past. In this case, the weight update unit 11 may acquire the evaluation information including the model input information for evaluation and the true value. However, the model input information for evaluation included in the evaluation information only needs to be information over time after the operation of the plurality of models f_i has started, and is not limited to the above-described example.

The weight update unit 11 may update some or all of the plurality of first weight vectors w⁽¹⁾_j and some or all of the plurality of second weight vectors w⁽²⁾_k based on the plurality of pieces of evaluation information and the evaluation result of the performance of each model f_i with reference to the plurality of pieces of evaluation information. The performance evaluation result of each model f_i with reference to the plurality of pieces of evaluation information may be, for example, a statistical value (for example, an average value, a maximum value, a minimum value, and the like) of the performance evaluation result of each model f_i with reference to each piece of evaluation information.

In a case where the additional information for evaluation is included in the evaluation information, the weight update unit 11 may update some or all of the plurality of first weight vectors w⁽¹⁾_j and some or all of the plurality of second weight vectors w⁽²⁾_k based on the performance evaluation result of each model f_i with reference to the evaluation information, and the model input information for evaluation and the additional information for evaluation included in the evaluation information.

For example, a set Deval of pieces of evaluation information input to the weight update unit 11 is expressed by the following Equation (9).

$${𝒟}^{eval} = {\{ ( {x}_{n} , {y}_{n} , {v}_{n} ) \}}_{n = 1}^{{N}^{eval}} \qquad Equation ( 9 )$$

In Equation (9), xₙ represents model input information included in the n-th evaluation information among the Neval pieces of evaluation information, and yₙ represents a true value included in the n-th evaluation information. vₙ indicates additional information for evaluation included in the n-th evaluation information among the Neval pieces of evaluation information. The value of Neval may be 1.

For example, for at least one of the plurality of first conditions c⁽¹⁾_j, the weight update unit 11 may extract one or more pieces of evaluation information satisfying the first condition c⁽¹⁾_j from the plurality of pieces of evaluation information. The processing of extracting one or more pieces of evaluation information satisfying the first condition c⁽¹⁾_j is expressed by, for example, the following Equation (10).

$${𝒟}_{j}^{( 1 ) eval} := \{ ( x , y , v ) ∈ {𝒟}^{eval} \vert {c}_{j}^{( 1 )} ( x , v ) \} \qquad Equation ( 10 )$$

In Equation (10), the left side (hereinafter, also described as D(1)eval_j) is a subset of Deval and indicates a set of evaluation information satisfying the first condition c⁽¹⁾_j.

The weight update unit 11 updates the first weight vector w⁽¹⁾_j associated with the first condition c⁽¹⁾_j based on the evaluation result obtained by evaluating the performance of each model f_i using the one or more pieces of extracted evaluation information (D(1)eval_j). Equation (10) represents a case where the evaluation information includes the additional information for evaluation, and c⁽¹⁾_j(x, v) is true in a case where the model input information x for evaluation and the additional information v for evaluation included in the evaluation information satisfy the first condition c⁽¹⁾_j, and is false in a case where they do not satisfy the first condition c⁽¹⁾_j.

For example, it is assumed that five pieces of evaluation information are included in the set Deval, the weekday/holiday label included in the model input information for evaluation of three pieces of evaluation information is “weekday”, and the weekday/holiday label included in the model input information for evaluation of the remaining two pieces of evaluation information is “holiday”. In this case, the former three pieces of evaluation information satisfying the first condition c⁽¹⁾_1 “weekday” are extracted as the subset D(1)eval_1. The latter two pieces of evaluation information satisfying the first condition c⁽¹⁾_2 “holiday” are extracted as the subset D(1)eval_2.

Similarly, for at least one of the plurality of second conditions c⁽²⁾_k, the weight update unit 11 may extract one or more pieces of evaluation information satisfying the second condition c⁽²⁾_k from the plurality of pieces of evaluation information. The processing of extracting one or more pieces of evaluation information satisfying the second condition c⁽²⁾_k is expressed by, for example, the following Equation (11).

$${𝒟}_{k}^{( 2 ) eval} := \{ ( x , y , v ) ∈ {𝒟}^{eval} \vert {c}_{k}^{( 2 )} ( x , v ) \} \qquad Equation ( 11 )$$

In Equation (11), the left side (hereinafter, also described as D(2)eval_k) is a subset of Deval and indicates a set of evaluation information satisfying the second condition c⁽²⁾_k.

The weight update unit 11 updates the second weight vector w⁽²⁾_k associated with the second condition c⁽²⁾_k based on the evaluation result of evaluating the first weight vector using the one or more pieces of extracted evaluation information (D(2)eval_k). Equation (11) represents a case where the evaluation information includes the additional information for evaluation, and c⁽²⁾_k(x, v) is true in a case where the model input information x for evaluation and the additional information v for evaluation included in the evaluation information satisfy the second condition c⁽²⁾_k, and is false in a case where they do not satisfy the second condition c⁽²⁾_k.

For example, it is assumed that five pieces of evaluation information are included in the set Deval, the weekday/holiday label included in the model input information for evaluation of three pieces of evaluation information is “weekday”, and the weekday/holiday label included in the model input information for evaluation of the remaining two pieces of evaluation information is “holiday”. In this case, the former three pieces of evaluation information satisfying the second condition c⁽²⁾_1 “weekday” are extracted as the subset D(2)eval_1. The latter two pieces of evaluation information satisfying the second condition c⁽²⁾_2 “holiday” are extracted as the subset D(2)eval_2.

### (Flow of Prediction Method)

A prediction method S1A executed by the prediction device 1A configured as described above will be described substantially similarly to the prediction method S1 described with reference to FIG. 2. However, the details of the weight update processing S11 and the details of the prediction processing S12 will be described more specifically as follows.

### (Detailed Flow of Weight Update Processing)

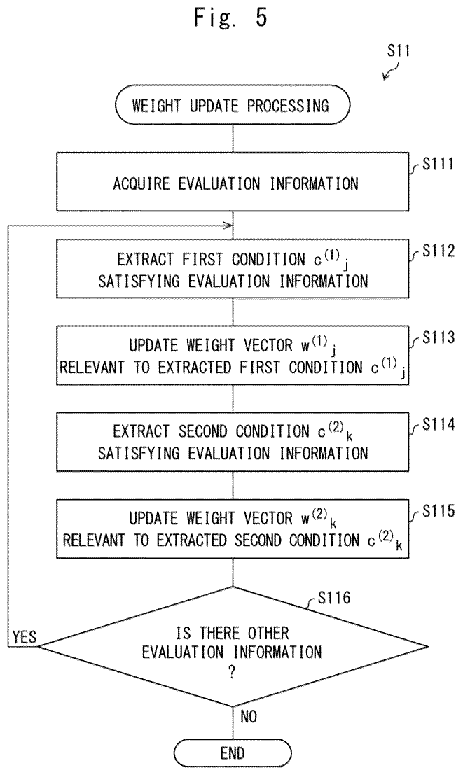

First, a detailed flow of the weight update processing S11 will be described with reference to FIG. 5. FIG. 5 is a flowchart for explaining an example of a detailed flow of the weight update processing S11. As illustrated in FIG. 5, the weight update processing S11 includes steps S111 to S116.

### (Step S111)

In step S111, the weight update unit 11 acquires the evaluation information. For example, in a case where the prediction method S1A has been executed in the past, the weight update unit 11 may acquire the evaluation information including the model input information included in the prediction target information used in the past prediction processing S12 as the model input information for evaluation. If the number of unprocessed pieces of evaluation information among the acquired pieces of evaluation information reaches a predetermined number, the weight update unit 11 may execute the processing of the next step S112 and subsequent steps using the predetermined number of pieces of evaluation information.

### (Step S112)

Subsequently, in step S112, the weight update unit 11 extracts the first condition c⁽¹⁾ⱼ satisfied by the evaluation information acquired in step S111 from the plurality of first conditions. As an example, the weight update unit 11 extracts a plurality of first conditions c⁽¹⁾ⱼ (for example, c⁽¹⁾₁ “sunny weekday”, c⁽¹⁾₅ “sunny”, c⁽¹⁾₇ “all samples”, and the like among the plurality of first conditions illustrated in FIG. 4) satisfied by the evaluation information. The processing in this step may include processing of extracting, from the set Deval of the evaluation information, a subset D(1)eval_j of the evaluation information satisfying the first condition c⁽¹⁾ⱼ satisfied by the evaluation information acquired in step S111. Here, an example of the subset D(1)eval_j of the evaluation information is as described with reference to Equation (10).

### (Step S113)

Subsequently, in step S113, the weight update unit 11 updates the first weight vector w⁽¹⁾ⱼ relevant to the first condition c⁽¹⁾ⱼ extracted in step S112. As an example, the weight update unit 11 updates a plurality of first weight vectors w⁽¹⁾₁, w⁽¹⁾₅, and w⁽¹⁾₇ relevant to a plurality of first conditions c⁽¹⁾₁ “sunny weekday”, c⁽¹⁾₅ “sunny”, and c⁽¹⁾₇ “all samples”. For the update processing of these first weight vectors, as an example, the subsets D(1)eval_1, D(1)eval_5, and D(1)eval_7 of the evaluation information extracted in step S112 are used. However, this does not limit this example.

More specifically, the weight update unit 11 performs processing of:
deriving an evaluation result of each model with reference to the prediction value y\hat{ }ᵢ=fᵢ(x) (i=1, . . . , Nmodel) of each model and the true value (correct value) y; and
updating the element w⁽¹⁾_{j,i} that is an element of the first weight vector w⁽¹⁾ⱼ and is relevant to the model fᵢ, with reference to the derived evaluation result. Here, a specific update algorithm is not intended to limit the present example embodiment, but as an example, a H algorithm may be used.

$${w}_{j , i}^{( 1 )} ← {w}_{j , i}^{( 1 )} exp ( - η {ℓ}_{i} ) \qquad Equation ( 12 )$$

The element w⁽¹⁾_{j,i} may be updated by this equation. Here,

$${ℓ}_{i} = ℓ ( y , ) \qquad Equation ( 13 )$$

represents a loss function (evaluation result of the model) defined by the prediction value y\hat{ }ᵢ and the true value y, and η represents a learning rate.

In a case where D(1)eval_j includes a plurality of samples, an average value of the loss function

$${1}_{i}^{mean} = {\sum }_{\{ ( x , y ) in D ( 1 ) eval \_ j \}} 1 ( y , {f}_{i} ( x ) )$$

may be used as the evaluation result of the model. In this case, li in Equation (12) may be replaced with Iᵢ^{mean}. Instead of the average value of the loss function, a statistical amount such as a maximum value or a minimum value of the loss function may be used.

### (Step S114)

Subsequently, in step S114, the weight update unit 11 extracts the second condition c⁽²⁾ₖ satisfied by the evaluation information acquired in step S111 from the plurality of second conditions. As an example, the weight update unit 11 extracts one second condition c⁽²⁾ₖ (for example, the second condition c⁽²⁾₁ illustrated in FIG. 4) satisfied by the evaluation information. The processing in this step may include processing of extracting, from the set Deval of the evaluation information, a subset D(2)eval_k of the evaluation information satisfying the second condition c⁽²⁾ⱼ satisfied by the evaluation information acquired in step S111. Here, an example of the subset D(2)eval_k of the evaluation information is as described with reference to Equation (11).

### (Step S115)

Subsequently, in step S115, the weight update unit 11 updates the second weight vector w⁽²⁾ₖ relevant to the second condition c⁽²⁾ₖ extracted in step S114. As an example, the weight update unit 11 updates one second weight vector w⁽²⁾₁ relevant to one second condition c⁽¹⁾₁ “sunny weekday”. For the update processing of the second weight vector, as an example, the subset D(2)eval_1 of the evaluation information extracted in step S114 is used. However, this does not limit this example.

More specifically, the weight update unit 11 calculates a prediction value for the evaluation information for each of the first conditions c⁽¹⁾ⱼ (j=1, . . . , Nweight(1)) by using the first weight vector w⁽¹⁾ⱼ updated in step S113. In other words, the weight update unit 11 calculates the prediction value y\hat{ }⁽¹⁾ⱼ by the following equation.

$$= {\sum }_{i} {w}_{j , i}^{( 1 )} {f}_{i} ( x ) \qquad Equation ( 14 )$$

Then, the weight update unit 11 performs processing of:
deriving an evaluation result of each first weight vector with reference to each prediction value y\hat{ }⁽¹⁾ⱼ and a true value (correct value) y; and
updating each element w⁽²⁾_{k,j} that is an element of the second weight vector w⁽²⁾ⱼ and is relevant to each first condition c⁽¹⁾ⱼ (in other words, each element relevant to the first weight vector w⁽¹⁾ⱼ), with reference to the derived evaluation result. Here, a specific update algorithm does not limit the present example embodiment, but as an example, a Hedge algorithm may be used as in step S113.

### (Step S116)

In step S116, the weight update unit 11 determines whether there is another piece of evaluation information that has not been processed yet. In a case where there is another piece of evaluation information that has not yet been processed (YES in step S116), the processing from step S112 is repeated. Otherwise (NO in step S116), the process ends.

### (Detailed Flow of Prediction Processing)

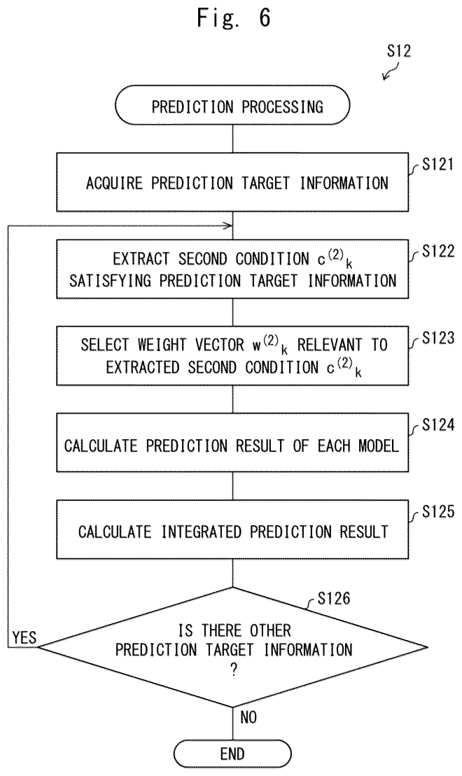

Next, details of the prediction processing S12 will be described with reference to FIG. 6. FIG. 6 is a flowchart illustrating an example of a detailed flow of the prediction processing S12. As illustrated in FIG. 6, the prediction processing S12 includes steps S121 to S126.

### (Step S121)

First, in step S121, the prediction unit 12 acquires a set X of prediction target information. The prediction unit 12 may acquire a set X of prediction target information stored in a memory included in the prediction device 1A, or may acquire a set X of prediction target information received via a network. The set X of prediction target information only needs to include at least one piece of prediction target information, and is not limited to including a plurality of pieces of prediction target information. An example of the set X is as described with reference to Equation (7) and the like.

### (Step S122)

Subsequently, in step S122, the prediction unit 12 extracts a second condition c⁽²⁾_k satisfied by the prediction target information from the plurality of second conditions. As an example, the prediction unit 12 extracts one second condition c⁽²⁾_k determined by the prediction target information from the plurality of second conditions.

### (Step S123)

Subsequently, in step S123, the prediction unit 12 selects the second weight vector W⁽²⁾_k associated with the second condition c⁽²⁾_k extracted in step S122.

### (Step S124)

Subsequently, in step S124, the prediction unit 12 calculates a prediction result fᵢ(x) of each model.

### (Step S125)

Subsequently, in step S125, the prediction unit 12 calculates the integrated prediction result y\hat{ } by using the second weight vector w⁽²⁾_k selected in step S123 by

$$\hat{y} = {\sum }_{j} {w}_{k , j}^{( 2 )} {\sum }_{i} {w}_{j , i}^{( 1 )} {f}_{i} ( x ) \qquad Equation ( 15 )$$

This example illustrates an example of a regression task. In Equation (15), each weight vector is assumed to be normalized to satisfy the following equations.

$${\sum }_{j} {w}_{k , j}^{( 2 )} = 1$$

$${\sum }_{i} {w}_{j , i}^{( 1 )} = 1.$$

In the case of a classification task, as an example, fᵢ(x) represents a vector of a class number dimension, and the prediction probability for each class label i is expressed by fᵢ(x). Then, the prediction unit 12 can calculate the post-integration prediction probability using the same equation as the above Equation (15). In a case where a label is to be finally determined as a prediction value, the prediction unit 12 determines a class label having the highest probability as the label as the prediction value.

### (Step S126)

In step S126, the prediction unit 12 determines whether the set X includes other prediction target information for which the integrated prediction result has not been calculated yet. In a case where other prediction target information is included (YES in step S126), the processing from step S122 is repeated for the other prediction target information. In a case where the other prediction target information is not included, the integrated prediction result y\hat{ } calculated in step S125 is output, and the process ends. The next weight update processing S11 may be executed using the evaluation information including the model input information included in the prediction target information used in the prediction processing S12 as the model input information for evaluation. However, similarly to the first example embodiment, the weight update processing S11 and the prediction processing S12 may be executed independently of each other, and the execution order and the execution timing of each processing are not defined.

### (Effects of Prediction Device 1A)

According to the prediction device 1A configured as described above, similarly to the prediction device 1 according to the first example embodiment, it is possible to accurately update some or all of the plurality of first weight vectors and some or all of the plurality of second weight vectors based on the evaluation result of each model evaluated with reference to the evaluation information and based on the evaluation information referred to for obtaining the evaluation result. At the time of performing prediction, the weight vector selected based on the prediction target information from the plurality of first weight vectors and the plurality of second weight vectors thus updated is used, and thus, it is possible to obtain an effect that the ensemble prediction can be performed with high accuracy even in a case where the distribution of the model input information included in the prediction target information locally changes.

The second weight vector may be a vector having a weight given to each of the plurality of first weight vectors as a component, and the plurality of first weight vectors may include a weight vector associated with a condition obtained by integrating any two or more conditions included in the plurality of first conditions.

With such a configuration, even if the setting of the first condition c⁽¹⁾ⱼ is not necessarily appropriate, suitable ensemble prediction can be executed. A more specific example of the effect will be described below.

For example, in the example illustrated in FIG. 4, it is assumed that almost no evaluation information satisfying the first condition c⁽¹⁾₂ “sunny holiday” has occurred. In this case, in the configuration in which the second weight vector w⁽²⁾ₖ is not used, the update frequency of the first weight vector w⁽¹⁾₂ relevant to the first condition c⁽¹⁾₂ decreases, and as a result, the accuracy of the ensemble prediction may decrease.

On the other hand, actually, the evaluation information satisfying the first condition c⁽¹⁾₁ “sunny weekday” and the evaluation information satisfying the first condition c⁽¹⁾₂ “sunny weekday” may be linked with each other. Similarly, there may be a case where the evaluation information satisfying the first condition c⁽¹⁾₃ “rainy weekday” and the evaluation information satisfying the first condition c⁽¹⁾₄ “rainy weekday” are linked (a distribution shift occurs in conjunction). In such a case, as the first condition, if rough condition settings such as “sunny” and “rainy” are used, a problem that the update frequency of the first weight vector decreases and the accuracy of the ensemble prediction decreases does not occur.

As described above, in the configuration in which the condition and the weight are associated with each other, how to set the condition can greatly affect the prediction accuracy. However, in the present example embodiment, as described above, the second weight vector w⁽²⁾ₖ having the weight given to each of the plurality of first weight vectors w⁽¹⁾ⱼ as a component is adopted, and the plurality of first weight vectors w⁽¹⁾ⱼ may include a weight vector associated with a condition obtained by integrating any two or more conditions included in the plurality of first conditions. More specifically, in the example illustrated in FIG. 4, the plurality of first conditions c⁽¹⁾j (j=1, . . . , 7) include:
a condition c⁽¹⁾₅ “sunny” obtained by integrating the first condition c⁽¹⁾₁ “sunny weekday” and the first condition c⁽¹⁾₂ “sunny holiday”; and
a condition c⁽¹⁾₆ “rain” obtained by integrating the first condition c⁽¹⁾₃ “rainy weekday” and the first condition c⁽¹⁾₄ “rainy holiday”.
   Therefore, even if the settings of the first conditions c⁽¹⁾₁ to c⁽¹⁾₄ are not necessarily appropriate, a decrease in the update frequency of the first weight vector can be suppressed, and a decrease in the accuracy of the ensemble prediction can be suppressed.

By adopting the second weight vector w⁽²⁾ₖ, there is also a secondary effect that information regarding the relationship between mutually different conditions can be acquired from the component of the second weight vector w⁽²⁾ₖ. For example, in a second vector

$${w}_{2}^{( 2 )} = ( {w}_{2 , 1 , … ,}^{( 2 )} {w}_{2 , Nweight ( 1 )}^{( 2 )} )$$

associated with a second condition c⁽²⁾₂, it is assumed that the value of the component w⁽²⁾_{2,1} is 1 and the other components are almost zero. In such a case, it can be inferred that a similar distribution shift occurs between the second condition c⁽²⁾₂ “sunny holiday” and the first condition c⁽²⁾₁ “sunny weekday”.

### Third Example Embodiment

A third example embodiment that is an example of an example embodiment of the present disclosure will be described in detail with reference to the drawings. Components having the same functions as the components described in the above-described example embodiments are denoted by the same reference signs, and the description thereof will be appropriately omitted. The application range of each technical means adopted in the present example embodiment is not limited to the present example embodiment. That is, each technical means adopted in the present example embodiment can also be adopted in other example embodiments included in the present disclosure as long as no particular technical problem occurs. Each technique illustrated in each of the drawings referred to for describing the present example embodiment can be employed in the other example embodiments included in the present disclosure within a range in which no particular technical problem occurs.

### (Prediction Device 1B)

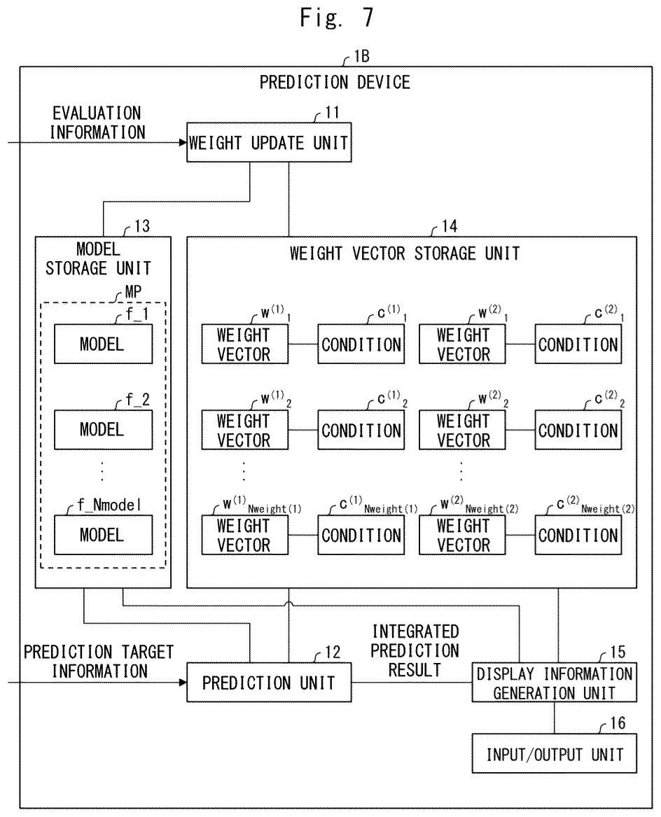

FIG. 7 is a block diagram illustrating a configuration of a prediction device 1B according to the present example embodiment. As illustrated in FIG. 7, the prediction device 1B according to the present example embodiment includes a display information generation unit 15 and an input/output unit 16 in addition to each configuration included in the prediction device 1A according to the second example embodiment.

The display information generation unit 15 generates display information with reference to the integrated prediction result derived by the prediction unit 12, the model pool MP, and the first weight vector and the second weight vector.

The input/output unit 16 includes at least one of input/output devices such as a keyboard, a mouse, a display, a printer, and a touch panel. Alternatively, input/output devices such as a keyboard, a mouse, a display, a printer, and a touch panel may be connected to the input/output unit 16. With such a configuration, the input/output unit 16 receives inputs of various types of information to the prediction device 1B from the connected input device. The input/output unit 16 outputs various types of information to the connected output device. The input/output unit 16 may adopt, for example, an interface such as a universal serial bus (USB).

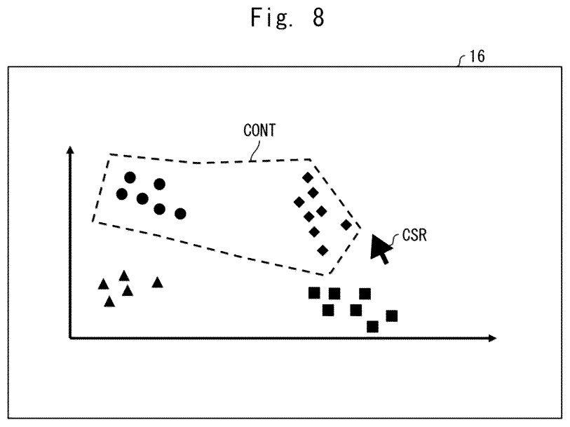

FIG. 8 illustrates an example of display information generated by the display information generation unit 15 and displayed via the input/output unit 16. As illustrated in FIG. 8, the display information includes, as an example, a plurality of data points obtained by embedding the model input information (explanatory variable) in a low-dimensional space (two-dimensional space in the case of FIG. 8).

In the example illustrated in FIG. 8, data points indicated by the model input information are illustrated using markers having different shapes for each condition satisfied by the model input information. As an example, the data points indicated using the round marker indicate the data points indicated by the model input information (explanatory variable) satisfying the second condition c⁽²⁾₁, and the data points indicated using the diamond marker indicate the data points indicated by the model input information (explanatory variable) satisfying the second condition c⁽²⁾₂.

The prediction unit 12 may specify a set of conditions in which a change occurs in conjunction among a plurality of conditions by referring to the second weight vector, and reflect the set of conditions in the display information. In the example of FIG. 8, the prediction unit 12 finds that the condition satisfied by the model input information indicated by the round data points and the condition satisfied by the model input information indicated by the diamond data points are linked, and the display information generation unit 15 includes the boundary line CONT surrounding these data points in the display information.

As illustrated in FIG. 8, the input/output unit 16 may be configured to display a cursor CSR operable by the user and to select each data point. The display information generation unit 15 may be configured to generate additional information to be presented to the user based on an input from the user.

### First Modified Example

In the above-described example embodiment, a case where the first weight vector and the first condition are associated on a one-to-one basis and the second weight vector and the second condition are associated on a one-to-one basis has been mainly described. Alternatively, at least one of the plurality of first weight vectors may be associated with two or more of the plurality of first conditions. Similarly, at least one of the plurality of second weight vectors may be associated with two or more conditions among the plurality of second conditions.

For example, it is assumed that a first condition A and a first condition B are associated with the same first weight vector. In this case, the weight update unit 11 may update the first weight vector based on an evaluation result EA obtained by evaluating the performance of each model f_i using the evaluation information satisfying the first condition A and an evaluation result EB obtained by evaluating the performance of each model f_i using the evaluation information satisfying the first condition B. For example, the weight update unit 11 may update the first weight vector using a statistical value (average value or the like) calculated from the evaluation result EA and the evaluation result EB, but is not limited thereto.

At least two or more first weight vectors among the plurality of first weight vectors may be associated with any one of the plurality of first conditions. Similarly, at least two or more second weight vectors of the plurality of second weight vectors may be associated with any one of the plurality of second conditions.

For example, it is assumed that the first weight vector A and the first weight vector B are associated with the same condition. In this case, the weight update unit 11 may update the first weight vector A and the first weight vector B based on the evaluation result obtained by evaluating the performance of each model f_i using the evaluation information satisfying the condition. In a case where the prediction target information satisfies the condition, the prediction unit 12 may obtain the integrated prediction result using the weight vector (for example, a vector having an average value of each element as an element) calculated from the first weight vector A and the first weight vector B associated with the condition.

For example, in a case where the condition c_1 “weekday” and the condition c_2 “holiday” are set as the first condition, and the weight vectors w_1, w_2, and w_3 are present as the first weight vectors, the weight vectors w_1 and w_2 may be associated with the condition c_1 “weekday”, and the weight vectors w_2 and w_3 may be associated with the condition c_2 “holiday”. In other words, there may be two weight vectors relevant to weekdays and two weight vectors relevant to holidays. One weight vector may be relevant to both a weekday and a holiday.

### Second Modified Example

In the above-described example embodiment, the plurality of first conditions c⁽¹⁾_j and the plurality of second conditions c⁽²⁾_k may be determined based on, for example, a rule given by the user. The plurality of first conditions c⁽¹⁾_j and the plurality of second conditions c⁽²⁾_k may be determined by clustering a plurality of pieces of prediction target information given in advance. For example, clustering may be performed on a plurality of pieces of prediction target information given in advance using a hard clustering method such as a K-means method or hierarchical clustering such that each piece of prediction target information belongs to one cluster. In this case, belonging to each of the plurality of clusters indicated by the clustering result may be defined as each condition c⁽¹⁾_j or c⁽²⁾_k. Some or all of the plurality of first conditions c⁽¹⁾_j and the plurality of second conditions c⁽²⁾_k may change during operation.

### Third Modified Example

For example, a soft clustering method such as a Fuzzy C-means method or a Gaussian mixture model may be used for clustering in advance in the second modified example. In this case, for example, a membership value indicating the degree to which the prediction target information belongs to each of the plurality of clusters is calculated. Also in this case, belonging to each of the plurality of clusters indicated by the clustering result may be defined as each condition c⁽¹⁾_j or c⁽²⁾_k.

### Fourth Modified Example

In a case where a plurality of first conditions c⁽¹⁾_j or second conditions c⁽²⁾_k are determined by soft clustering as in the third modified example, the weight update unit 11 may be modified as follows. The weight update unit 11 may calculate the degree to which the evaluation information satisfies each of the plurality of conditions, and may update some or all of the plurality of weight vectors according to the degree to which each condition as either the first condition or the second condition is satisfied.

For example, as a method of calculating the degree to which the evaluation information satisfies each of the plurality of conditions, a soft clustering method can be applied similarly to the third modified example. For example, it is assumed that the model input information does not include a weekday/holiday label but includes a store periphery image. In this case, the weight update unit 11 may calculate, from the store periphery image, the degree that a photographing date of the image is a weekday (degree of satisfying the condition c_1) and the degree that the photographing date is a holiday (degree of satisfying the condition c_2). For example, as a specific example, it is assumed that the degree “0.3” satisfying the condition c_1 “weekday” and the degree “0.7” satisfying the condition c_2 “holiday” are calculated for certain evaluation information. In this case, the weight update unit 11 may update each element in such a way that a value obtained by multiplying a difference before and after update of each element in a case where the evaluation result of the performance of each model f_i with reference to the evaluation information is directly applied to the first weight vector w⁽¹⁾_1 by 0.3 becomes a difference. The weight update unit 11 may update each element such that a value obtained by multiplying a difference before and after update of each element in a case where the evaluation result of the performance of each model f_i with reference to the evaluation information is directly applied to the first weight vector w⁽¹⁾_2 by 0.7 becomes a difference.

### Fifth Modified Example

In a case where the first condition c⁽¹⁾_j or the second condition c⁽²⁾_k is determined by soft clustering as in the third modified example, the prediction unit 12 may be modified as follows. The prediction unit 12 may calculate the degree to which the prediction target information satisfies each of the plurality of conditions, and integrate the prediction results predicted by the models f_i by using an integrated weight vector obtained by integrating a plurality of weight vectors according to the degree to which each condition as either the first condition or the second condition is satisfied.

For example, as a method of calculating the degree to which the prediction target information satisfies each of the plurality of conditions, a soft clustering method can be applied similarly to the third modified example. For example, the degree to which the prediction target information satisfies each of the first conditions c⁽¹⁾_j (as an example, the membership value of each cluster) is expressed by the following Equation (16).

$${m}^{( 1 )} = ( {m}_{1}^{( 1 )} , … , {m}_{{N}^{weight ( 1 )}}^{( 1 )} ) \qquad Equation ( 16 )$$

In Equation (16), m⁽¹⁾_j represents a value obtained by quantifying the degree to which the prediction target information satisfies the first condition c⁽¹⁾_j. In this case, the prediction unit 12 can calculate a first integrated weight vector w⁽¹⁾ by the following Equation (17).

$${w}^{( 1 )} = \frac{1}{\vert {m}^{( 1 )} \vert} {\sum }_{j = 1}^{{N}^{weight ( 1 )}} {m}_{j}^{( 1 )} {w}_{j}^{( 1 )} \qquad Equation ( 17 )$$

In Equation (17), the integrated weight vector w⁽¹⁾ on the left side represents a weighted average of the plurality of first weight vectors w⁽¹⁾_j.

Similarly, the degree to which the prediction target information satisfies each of the second conditions c⁽²⁾_k (as an example, the membership value of each cluster) is expressed by the following Equation (18).

$${m}^{( 2 )} = ( {m}_{1}^{( 2 )} , … , {m}_{{N}^{weight ( 2 )}}^{( 2 )} ) \qquad Equation ( 18 )$$

In Equation (18), m⁽²⁾_k represents a value obtained by quantifying the degree to which the prediction target information satisfies the second condition c^{(k)}_k. In this case, the prediction unit 12 can calculate a second integrated weight vector w⁽²⁾ by the following Equation (19).

$${w}^{( 2 )} = \frac{1}{\vert {m}^{( 2 )} \vert} {\sum }_{k = 1}^{{N}^{weight ( 2 )}} {m}_{k}^{( 2 )} {w}_{k}^{( 2 )} \qquad Equation ( 19 )$$

In Equation (19), the integrated weight vector w⁽²⁾ on the left side represents a weighted average of the plurality of second weight vectors w⁽²⁾_k.

For example, it is assumed that the model input information does not include the weekday/holiday label but includes the store periphery image, and the degree “0.3” satisfying the first condition c⁽¹⁾_1 “weekday” and the degree “0.7” satisfying the first condition c⁽¹⁾_2 “holiday” are calculated for the prediction target information. In this case, the prediction unit 12 assigns a weight 0.3 to the weight vector w⁽¹⁾_1 associated with the condition c⁽¹⁾_1, and assigns a weight 0.7 to the weight vector w⁽¹⁾_2 associated with the condition c⁽¹⁾_2, thereby calculating the weighted average of the weight vectors w⁽¹⁾_1 and w⁽¹⁾_2 as the first integrated weight vector w⁽¹⁾. The same applies to the second weight vector. The prediction unit 12 calculates the integrated prediction result by integrating the prediction result y_i output from each model f_i with reference to the model input information included in the prediction target information using the first integrated weight vector w^{(l)} and the second integrated weight vector w⁽²⁾.

### Sixth Modified Example

As partially described above, the present example embodiment is not limited to the example in which the prediction task is a regression task such that the prediction target is, for example, the sales amount on the target date, and the prediction task may be a classification task. In that case, the prediction unit 12 may use the weighted average of the prediction results (prediction probabilities of classifications) by the models f_i as the integrated prediction result (prediction probability of classification). Alternatively, the prediction unit 12 may use weighted majority decision of the prediction result (classification) by each model f_i as the integrated prediction result (classification).

### First Application Example

Hereinafter, application examples of the prediction devices 1, 1A, and 1B described above will be described. In the following description, an application example of the prediction device 1A will be described, but application examples of the prediction devices 1 and 1B can be similarly achieved.

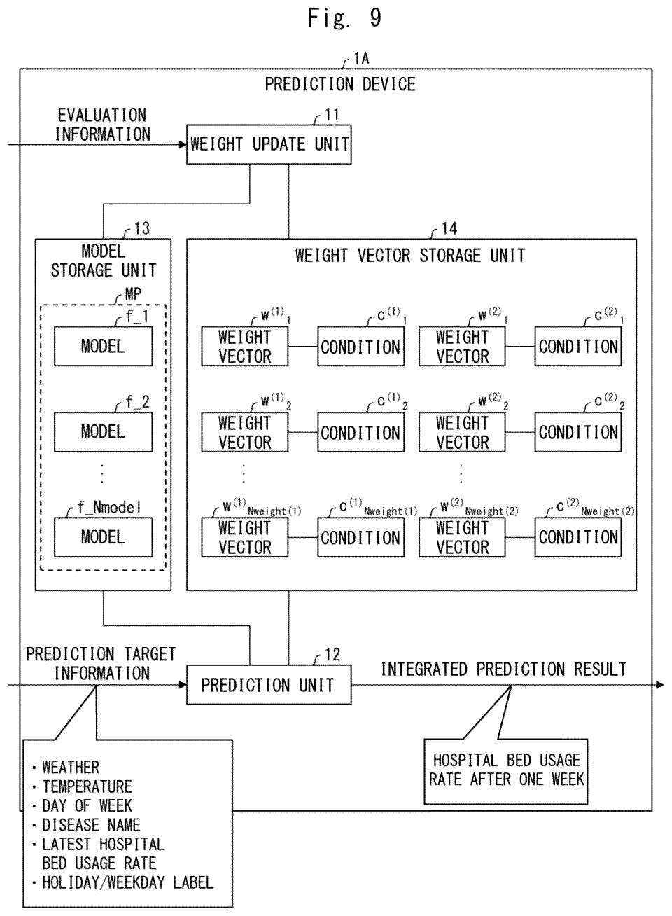

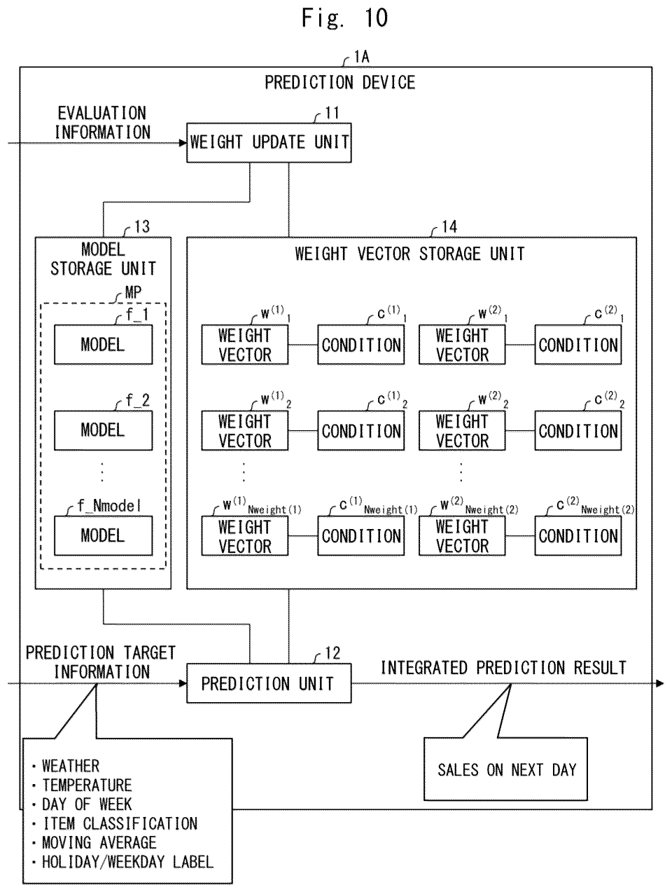

For example, the prediction device 1A is applicable in the medical field. A specific example of the prediction device 1A applied in the medical field will be described with reference to FIG. 9. FIG. 9 is a schematic diagram illustrating a specific example of a prediction device 1A applied in the medical field. In this example, the prediction target is set to “hospital bed usage rate after one week”, and the model input information is set to “weather, temperature, day of week, disease name, latest hospital bed usage rate, holiday/weekday label”. Here, the information regarding weather is acquired from a weather providing server via an application programming interface (API) by communication via a communication unit (not illustrated) included in the prediction device 1A. The information regarding the temperature is acquired from a temperature sensor connected to the prediction device 1A via the input/output unit 16.

The prediction device 1A stores models f_1, f_2, and f_3. The models f_1, f_2, and f_3 are generated by different learning algorithms using training data in advance. The model f_1 is generated by a deep neural network (DNN), the model f_2 is generated by a gradient boosting decision tree (GBDT), and the model f_3 is generated by linear regression.

Then, the prediction device 1A repeats the weight update processing S11 and the prediction processing S12 using the condition setting illustrated in FIG. 4 and the first weight vector and the second weight vector. Then, the “hospital bed usage rate after one week” which is the integrated prediction result derived by the prediction device 1A is input to the reservation management system connected to the prediction device 1A, and is referred to for optimizing the number of beds to be secured. According to this configuration, even in a case where the distribution of the information related to the prediction target locally changes, the ensemble prediction can be performed with high accuracy.

As described above, in a case where the plurality of first conditions c⁽¹⁾ⱼ (j=1, . . . , 7) includes
the condition c⁽¹⁾₅ “sunny” obtained by integrating the first condition c⁽¹⁾₁ “sunny weekday” and the first condition c⁽¹⁾₂ “sunny holiday”,
the condition c⁽¹⁾₆ “rain” obtained by integrating the first condition c⁽¹⁾₃ “rainy weekday” and the first condition c⁽¹⁾₄ “rainy holiday”, and the like, as described above, even if the condition setting is not necessarily appropriate, a decrease in the update frequency of the weight vector can be suppressed, and a decrease in the accuracy of ensemble prediction can be suppressed. Therefore, since it is possible to output a highly accurate integrated prediction result, the prediction device 1A can suitably support decision-making of a hospital staff (medical worker) such as a doctor related to patient bed management.

### Second Application Example

As another example, the prediction device 1A is applicable to demand prediction. A specific example of the prediction device 1A applied to demand prediction will be described with reference to FIG. 10. FIG. 10 is a schematic diagram illustrating a specific example of a prediction device 1A applied to demand prediction. In this example, the prediction target is “sales on the next day”, and the model input information is “weather, temperature, day of week, item classification, moving average, holiday/weekday label”. Here, the information regarding weather is acquired from a weather providing server via an application programming interface (API) by communication via a communication unit (not illustrated) included in the prediction device 1A. The information regarding the temperature is acquired from a temperature sensor connected to the prediction device 1A via the input/output unit 16.

The prediction device 1A stores models f_1, f_2, and f_3. The models f_1, f_2, and f_3 are generated by different learning algorithms using training data in advance. The model f_1 is generated by a deep neural network (DNN), the model f_2 is generated by a gradient boosting decision tree (GBDT), and the model f_3 is generated by linear regression.

Then, the prediction device 1A repeats the weight update processing S11 and the prediction processing S12 using the condition setting illustrated in FIG. 4 and the first weight vector and the second weight vector. Then, “sales on the next day” that is the integrated prediction result derived by the prediction device 1A is input to a reservation management system connected to the prediction device 1A, and is referred to for optimizing the order quantity. According to this configuration, even in a case where the distribution of the information related to the prediction target locally changes, the ensemble prediction can be performed with high accuracy.

Here, as described above, in a case where the plurality of first conditions c⁽¹⁾ⱼ (j=1, . . . , 7) includes
the condition c⁽¹⁾₅ “sunny” obtained by integrating the first condition c⁽¹⁾₁ “sunny weekday” and the first condition c⁽¹⁾₂ “sunny holiday”,
the condition c⁽¹⁾₆ “rain” obtained by integrating the first condition c⁽¹⁾₃ “rainy weekday” and the first condition c⁽¹⁾₄ “rainy holiday”, and the like, as described above, even if the condition setting is not necessarily appropriate, a decrease in the update frequency of the weight vector can be suppressed, and a decrease in the accuracy of ensemble prediction can be suppressed. Therefore, a highly accurate integrated prediction result can be output.

### [Example of Implementation by Software]

Some or all of the functions of the prediction devices 1, 1A, and 1B (hereinafter, also referred to as “each of the above-described devices”) may be implemented by hardware such as an integrated circuit (IC chip) or may be implemented by software.

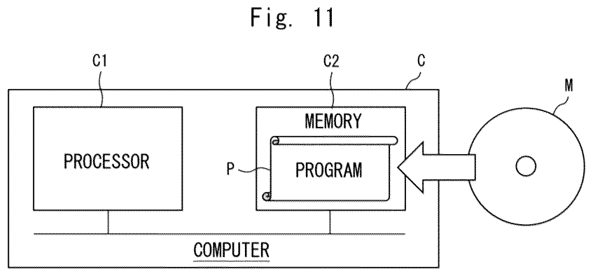

In the latter case, each of the above-described devices is implemented by, for example, a computer that executes a command of a program which is software for implementing each function. An example of such a computer (hereinafter, referred to as a computer C) is illustrated in FIG. 11. FIG. 11 is a block diagram illustrating a hardware configuration of the computer C functioning as each of the above-described devices.

The computer C includes at least one processor C1 and at least one memory C2. A program P for causing the computer C to operate as each of the above devices is recorded in the memory C2. In the computer C, the processor C1 reads the program P from the memory C2 and executes the program P to implement each function of each of the above-described devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

The program P can be stored and provided to the computer C using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program P may be provided to the computer C using any type of transitory computer readable media. Examples of transitory computer readable media include electric signals, optical signals, and electromagnetic waves. Transitory computer readable media can provide the program P to the computer C via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### Supplementary Notes A

The whole or part of the example embodiments disclosed above can be described as the following supplementary notes. However, the present disclosure is not limited to the technologies described in the following supplementary note, and various modifications can be made within the scope described in the claims.

### Supplementary Note A1

A prediction device including
a weight update means for updating some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and
a prediction means for outputting an integrated prediction result obtained by integrating prediction results predicted by each model with reference to model input information included in prediction target information related to a prediction target using a weight vector selected based on the prediction target information from among the plurality of first weight vectors and the plurality of second weight vectors.

### Supplementary Note A2

The prediction device according to Supplementary Note A1, in which
each of the plurality of first weight vectors is associated with at least one of a plurality of first conditions that can be satisfied by the prediction target information and can be satisfied by the evaluation information, and
the weight update means updates a first weight vector associated with a first condition satisfied by the evaluation information among the plurality of first conditions based on the evaluation result.

### Supplementary Note A3

The prediction device according to Supplementary Note A2, in which

each of the plurality of second weight vectors is associated with at least one of a plurality of second conditions that can be satisfied by the prediction target information and can be satisfied by the evaluation information,
the weight update means updates a second weight vector associated with a second condition satisfied by the evaluation information among the plurality of second conditions based on the evaluation result, and
the prediction means selects a second weight vector associated with a second condition satisfied by the prediction target information among the plurality of second conditions.

### Supplementary Note A4

The prediction device according to Supplementary Note A3, in which the second weight vector is a vector having a weight given to each of the plurality of first weight vectors as a component.

### Supplementary Note A5

The prediction device according to Supplementary Note A3 or A4, in which
a plurality of the first conditions satisfied by certain prediction target information are present for the prediction target information, and
the second condition satisfied by certain prediction target information is determined to be one for the prediction target information.

### Supplementary Note A6

The prediction device according to any one of Supplementary Notes A2 to A5, in which the plurality of first weight vectors include a weight vector associated with a condition obtained by integrating any two or more conditions included in the plurality of first conditions.

### Supplementary Note A7

The prediction device according to any one of Supplementary Notes A1 to A6, in which
the prediction target information further includes additional information that is not input to each model, in addition to the model input information, and
the evaluation information further includes the additional information for evaluation in addition to the model input information for evaluation.

### Supplementary Note A8

The prediction device according to any one of Supplementary Notes A1 to A7, in which at least one of the plurality of models is a machine learning model.

### Supplementary Notes B

The whole or part of the example embodiments disclosed above can be described as the following supplementary notes. However, the present disclosure is not limited to the technologies described in the following supplementary note, and various modifications can be made within the scope described in the claims.

### Supplementary Note B1

A prediction method including
weight update processing in which at least one processor updates some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and
prediction processing in which the at least one processor outputs an integrated prediction result obtained by integrating prediction results predicted by each model with reference to model input information included in prediction target information related to a prediction target using a weight vector selected based on the prediction target information from among the plurality of first weight vectors and the plurality of second weight vectors.

### Supplementary Note B2

The prediction method according to Supplementary Note B1, in which

each of the plurality of first weight vectors is associated with at least one of a plurality of first conditions that can be satisfied by the prediction target information and can be satisfied by the evaluation information, and
in the weight update processing, the at least one processor updates a first weight vector associated with a first condition satisfied by the evaluation information among the plurality of first conditions based on the evaluation result.

### Supplementary Note B3

The prediction method according to Supplementary Note B2, in which

each of the plurality of second weight vectors is associated with at least one of a plurality of second conditions that can be satisfied by the prediction target information and can be satisfied by the evaluation information,
in the weight update processing, the at least one processor updates a second weight vector associated with a second condition satisfied by the evaluation information among the plurality of second conditions based on the evaluation result, and
in the prediction processing, the at least one processor selects a second weight vector associated with a second condition satisfied by the prediction target information among the plurality of second conditions.

### Supplementary Note B4

The prediction method according to Supplementary Note B3, in which the second weight vector is a vector having a weight given to each of the plurality of first weight vectors as a component.

### Supplementary Note B5

The prediction device according to Supplementary Note B3 or B4, in which
a plurality of the first conditions satisfied by certain prediction target information are present for the prediction target information, and
the second condition satisfied by certain prediction target information is determined to be one for the prediction target information.

### Supplementary Note B6

The prediction method according to any one of Supplementary Notes B2 to B5, in which the plurality of first weight vectors include a weight vector associated with a condition obtained by integrating any two or more conditions included in the plurality of first conditions.

### Supplementary Note B7

The prediction method according to any one of Supplementary Notes B1 to B6, in which
the prediction target information further includes additional information that is not input to each model, in addition to the model input information, and
the evaluation information further includes the additional information for evaluation in addition to the model input information for evaluation.

### Supplementary Note B8

The prediction method according to any one of Supplementary Notes B1 to B7, in which at least one of the plurality of models is a machine learning model.

### Supplementary Notes C

The whole or part of the example embodiments disclosed above can be described as the following supplementary notes. However, the present disclosure is not limited to the technologies described in the following supplementary note, and various modifications can be made within the scope described in the claims.

### Supplementary Note C1

A prediction program for causing a computer to function as a prediction device, the program causing the computer to function as
a weight update means for updating some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and
a prediction means for outputting an integrated prediction result obtained by integrating prediction results predicted by each model with reference to model input information included in prediction target information related to a prediction target using a weight vector selected based on the prediction target information from among the plurality of first weight vectors and the plurality of second weight vectors.

### Supplementary Note C2

The prediction program according to Supplementary Note C1, in which
each of the plurality of first weight vectors is associated with at least one of a plurality of first conditions that can be satisfied by the prediction target information and can be satisfied by the evaluation information, and
the weight update means updates a first weight vector associated with a first condition satisfied by the evaluation information among the plurality of first conditions based on the evaluation result.

### Supplementary Note C3

The prediction program according to Supplementary Note C2, in which
each of the plurality of second weight vectors is associated with at least one of a plurality of second conditions that can be satisfied by the prediction target information and can be satisfied by the evaluation information,
the weight update means updates a second weight vector associated with a second condition satisfied by the evaluation information among the plurality of second conditions based on the evaluation result, and
the prediction means selects a second weight vector associated with a second condition satisfied by the prediction target information among the plurality of second conditions.

### Supplementary Note C4

The prediction program according to Supplementary Note C3, in which the second weight vector is a vector having a weight given to each of the plurality of first weight vectors as a component.

### Supplementary Note C5

The prediction device according to Supplementary Note C3 or C4, in which
a plurality of the first conditions satisfied by certain prediction target information are present for the prediction target information, and
the second condition satisfied by certain prediction target information is determined to be one for the prediction target information.

### Supplementary Note C6

The prediction program according to any one of Supplementary Notes C2 to C5, in which the plurality of first weight vectors include a weight vector associated with a condition obtained by integrating any two or more conditions included in the plurality of first conditions.

### Supplementary Note C7

The prediction program according to any one of Supplementary Notes C1 to C6, in which
the prediction target information further includes additional information that is not input to each model, in addition to the model input information, and
the evaluation information further includes the additional information for evaluation in addition to the model input information for evaluation.

### Supplementary Note C8

The prediction program according to any one of Supplementary Notes C1 to C7, in which at least one of the plurality of models is a machine learning model.

### Supplementary Notes D

The whole or part of the example embodiments disclosed above can be described as the following supplementary notes. However, the present disclosure is not limited to the technologies described in the following supplementary note, and various modifications can be made within the scope described in the claims.

### Supplementary Note D1

A prediction device including
at least one processor, in which
the at least one processor executes
weight update processing for updating some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and
prediction processing for outputting an integrated prediction result obtained by integrating prediction results predicted by each model with reference to model input information included in prediction target information related to a prediction target using a weight vector selected based on the prediction target information from among the plurality of first weight vectors and the plurality of second weight vectors.

The prediction device may further include a memory. The memory may store a program for causing the at least one processor to execute the process.

### Supplementary Note D2

The prediction device according to Supplementary Note D1, in which
each of the plurality of first weight vectors is associated with at least one of a plurality of first conditions that can be satisfied by the prediction target information and can be satisfied by the evaluation information, and
in the weight update processing, the at least one processor updates a first weight vector associated with a first condition satisfied by the evaluation information among the plurality of first conditions based on the evaluation result.

### Supplementary Note D3

The prediction device according to Supplementary Note D2, in which
each of the plurality of second weight vectors is associated with at least one of a plurality of second conditions that can be satisfied by the prediction target information and can be satisfied by the evaluation information,
in the weight update processing, the at least one processor updates a second weight vector associated with a second condition satisfied by the evaluation information among the plurality of second conditions based on the evaluation result, and
in the prediction processing, the at least one processor selects a second weight vector associated with a second condition satisfied by the prediction target information among the plurality of second conditions.

### Supplementary Note D4

The prediction device according to Supplementary Note D3, in which the second weight vector is a vector having a weight given to each of the plurality of first weight vectors as a component.

### Supplementary Note D5

The prediction device according to Supplementary Note D3 or D4, in which
a plurality of the first conditions satisfied by certain prediction target information are present for the prediction target information, and
the second condition satisfied by certain prediction target information is determined to be one for the prediction target information.

### Supplementary Note D6

The prediction device according to any one of Supplementary Notes D2 to D5, in which the plurality of first weight vectors include a weight vector associated with a condition obtained by integrating any two or more conditions included in the plurality of first conditions.

### Supplementary Note D7

The prediction device according to any one of Supplementary Notes D1 to D6, in which
the prediction target information further includes additional information that is not input to each model, in addition to the model input information, and
the evaluation information further includes the additional information for evaluation in addition to the model input information for evaluation.

### Supplementary Note D8

The prediction device according to any one of Supplementary Notes D1 to D7, in which at least one of the plurality of models is a machine learning model.

### Supplementary Notes E

The whole or part of the example embodiments disclosed above can be described as the following supplementary note. However, the present disclosure is not limited to the technologies described in the following supplementary note, and various modifications can be made within the scope described in the claims.

### Supplementary Note E1

A non-transitory computer-readable medium storing a program that causes a computer to execute:
weight update processing of updating some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and
prediction processing of outputting an integrated prediction result obtained by integrating prediction results predicted by each model with reference to model input information included in prediction target information related to a prediction target using a weight vector selected based on the prediction target information from among the plurality of first weight vectors and the plurality of second weight vectors.

Some or all of elements (e.g., structures and functions) specified in Supplementary Notes A2 to A8 dependent on Supplementary Note A1 may also be dependent on Supplementary Note E1 in dependency similar to that of Supplementary Notes A2 to A8 on Supplementary Note A1. Some or all of elements specified in any of Supplementary Notes may be applied to various types of hardware, software, and recording means for recording software, systems, and methods.

1. A prediction device comprising:
at least one memory storing instructions, and
at least one processor configured to execute the instructions to;
update some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information; and
output an integrated prediction result obtained by integrating prediction results predicted by each model with reference to model input information included in prediction target information related to a prediction target using a weight vector selected based on the prediction target information from among the plurality of first weight vectors and the plurality of second weight vectors.

2. The prediction device according to claim 1, wherein
each of the plurality of first weight vectors is associated with at least one of a plurality of first conditions that can be satisfied by the prediction target information and can be satisfied by the evaluation information, and
the at least one processor is further configured to execute the instructions to update a first weight vector associated with a first condition satisfied by the evaluation information among the plurality of first conditions based on the evaluation result.

3. The prediction device according to claim 2, wherein
each of the plurality of second weight vectors is associated with at least one of a plurality of second conditions that can be satisfied by the prediction target information and can be satisfied by the evaluation information, and
the at least one processor is further configured to execute the instructions to:
update a second weight vector associated with a second condition satisfied by the evaluation information among the plurality of second conditions based on the evaluation result, and
select a second weight vector associated with a second condition satisfied by the prediction target information among the plurality of second conditions.

4. The prediction device according to claim 3, wherein the second weight vector is a vector having a weight given to each of the plurality of first weight vectors as a component.

5. The prediction device according to claim 3, wherein
a plurality of the first conditions satisfied by certain prediction target information are present for the prediction target information, and
the second condition satisfied by certain prediction target information is determined to be one for the prediction target information.

6. The prediction device according to claim 2, wherein the plurality of first weight vectors include a weight vector associated with a condition obtained by integrating any two or more conditions included in the plurality of first conditions.

7. The prediction device according to claim 1, wherein
the prediction target information further includes additional information that is not input to each model, in addition to the model input information, and
the evaluation information further includes the additional information for evaluation in addition to the model input information for evaluation.

8. The prediction device according to claim 1, wherein at least one of the plurality of models is a machine learning model.

9. A prediction method comprising:
weight update processing in which at least one processor updates some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information; and
prediction processing in which the at least one processor outputs an integrated prediction result obtained by integrating prediction results predicted by each model with reference to model input information included in prediction target information related to a prediction target using a weight vector selected based on the prediction target information from among the plurality of first weight vectors and the plurality of second weight vectors.

10. A non-transitory computer-readable medium storing a program that causes a computer to execute:
a weight update processing of updating some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information; and
a prediction processing of outputting an integrated prediction result obtained by integrating prediction results predicted by each model with reference to model input information included in prediction target information related to a prediction target using a weight vector selected based on the prediction target information from among the plurality of first weight vectors and the plurality of second weight vectors.
